(19) United States
(12) Patent Application Publication
(10) Pub. No.: US 2008/0303715 A1
(43) Pub. Date: Dec. 11, 2008

(54) Display method for a dish of a DVB-S system

(76) Inventors: Chi-Leng Wang, Taipei City (TW); Yi-Chi Cheng, Taipei City (TW); Tien-Hsin Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/846,533

(22) Filed: Aug. 29, 2007

(30) Foreign Application Priority Data
Jun. 11, 2007 (CN) 200710109970.5

(51) Int. Cl. G01S 7/04

(52) U.S. Cl. 342/357.17

(57) ABSTRACT

A method for informing a user of the rotation of a dish in a Digital Video Broadcasting-Satellite system includes determining the duration of the rotation of the dish according to the angular velocity of the dish and the angle of the rotation; and outputting the duration of the rotation of the dish.

### BACKGROUND OF THE INVENTION

1. Field of the Invention

The present invention relates to a method displaying the movement of a dish, and more particularly, to a method displaying the movement of a dish in a DVB-S system (Digital Video Broadcasting-Satellite, DVB-S).

2. Description of the Prior Art

Please refer to FIG. 1. FIG. 1 is a diagram illustrating a DVB-S system 100. As shown in FIG. 1, the DVB-S system 100 comprises two satellites A and B, a dish 110, Set Top Box (STB) 120, and a TV 130. The dish 110 can be fixed and moveable. The dish 110 in FIG. 1 is moveable. When the dish 110 is aligned to the satellite A, the dish 110 receives the signals from satellite A, and displays the received signals from satellite A (for example, programs) on the TV 130 through the STB 120. Similarly, when the dish 110 is aligned with satellite B, the dish 110 receives the signals from satellite B, and displays the received signals from satellite B (for example, programs) on the TV 130 through the STB 120. If the user wants to watch programs from satellite B when the user is watching programs from the satellite A, the STB 120 turns the dish 110 from the position aligning with satellite A to the position aligning with the satellite B.

Conventionally, when the dish 110 is moving, the TV 130 displays an information “The dish is moving” to notify the user that the dish 110 is moving.

However, in a conventional system, the user only knows the dish is moving and does not know how long the dish has to move, and what from and to positions the dish moves. These details are not provided, causing inconvenience.

### SUMMARY OF THE INVENTION

The present invention provides a display method for a dish of a Digital Video Broadcasting Satellite (DVB-S). The display method comprises generating a first period of time of the dish spends rotating according to an angle the dish will be rotated and an angular velocity of the dish, and outputting the first period of time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a DVB-S system.

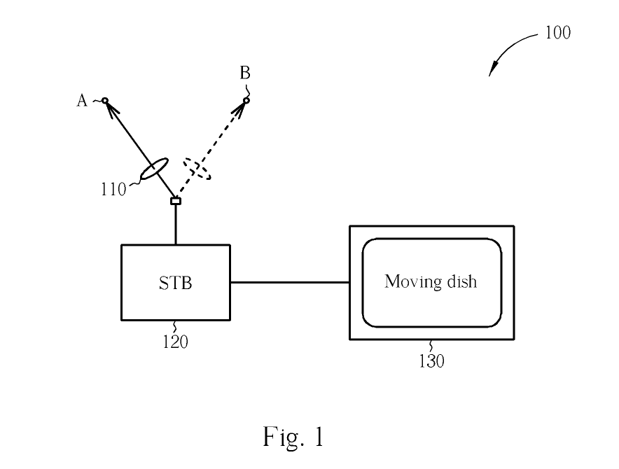

FIG. 2 is a flowchart illustrating the method for operating the dish of the DVB-S system of the present invention.

FIG. 3 is a diagram illustrating the message informing of the rotation of the dish of the present invention.

### DETAILED DESCRIPTION

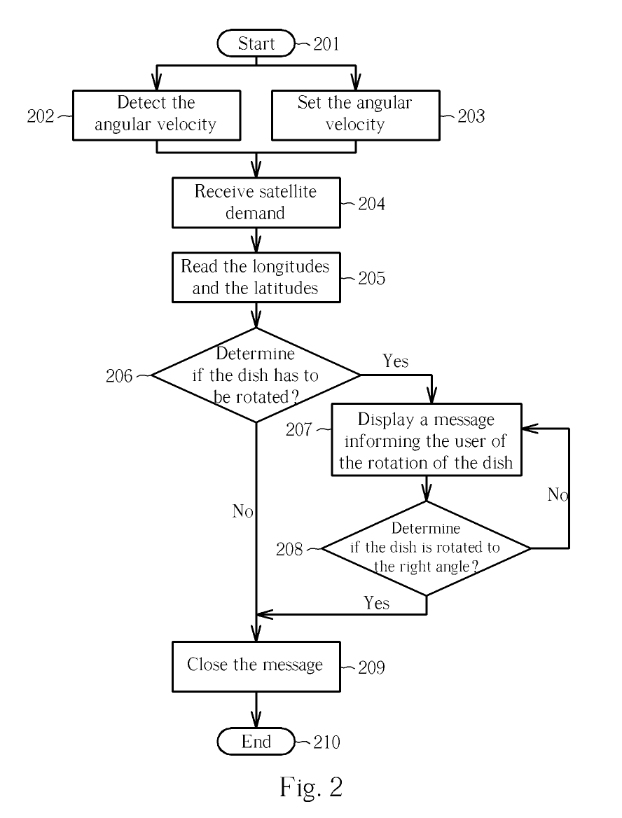

Please refer to FIG. 2. FIG. 2 is a flowchart illustrating the method for operating the dish of the DVB-S system of the present invention. The steps are described as follows:

Step 201: Start;

Step 202: Detect the angular velocity of the rotation of the dish;

Step 203: Set the angular velocity of the rotation of the dish;

Step 204: Receive satellite demand from the user;

Step 205: Read the longitudes and the latitudes of the demanded satellite saved in the data base;

Step 206: Determine if the dish has to be rotated;

Step 207: Display a message informing the user of the rotation of the dish;

Step 208: Determine if the dish is rotated to the right angle;

Step 209: Close the message;

Step 210: End.

In an embodiment of the present invention, when the STB 120 is reset, the angular velocity of the dish has also to be reset. The method to reset the velocity of the dish can be: 1) determine the angular velocity of the dish as described in step 202, or 2) the user inputs the angular velocity of the dish as described in the step 203. The method of detecting angular velocity of the dish can be: 1) choose any two satellites A and B of which locational data are saved in the database of the STB 120, 2) rotate the dish 110 from the angle aligning with satellite A to the angle aligning with satellite B, and 3) calculate the period of the rotation of the dish 110 from satellite A to satellite B. Thus, the angular velocity of the dish 110 is determined.

When receiving the satellite demand (for example, satellite C), the STB 120 determines if the dish 110 has to be rotated to align with satellite C. If yes, the STB 120 displays a message informing the user of the rotation of the dish until the dish 110 actually rotates to the angle aligning with satellite C. The method for determining if the dish 110 actually rotates to the angle aligning with satellite C is to detect the signals transmitted from satellite C.

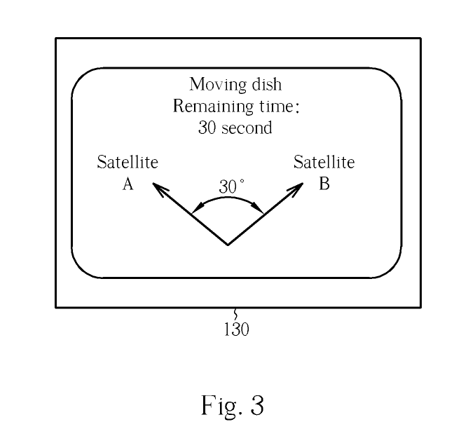

Please refer to FIG. 3. FIG. 3 is a diagram illustrating the message informing the user of the rotation of the dish according to the present invention. The present invention determines the time the dish has to spend rotating to the right angle according to the angular velocity of the dish and the angle difference between two satellites, and then displays the time on the TV screen, or alternatively outputting the information through an audio device or both on a display and via the audio device. In this way, the user is informed and knows how long he or she has to wait for programs of the satellite C to become available. As shown in FIG. 3, the example time to wait is 30 seconds, although obviously this figure may vary according to actual conditions. Additionally, the present invention also displays the angle difference between the two satellites on the TV screen as shown in FIG. 3. At first, the user watches the programs of satellite A, and then wants to watch the programs of satellite B. Thus, the dish 110 has to rotate from the angle aligning with satellite A to the angle aligning with satellite B (30 degrees as shown in FIG. 3, but varies according to actual conditions). Therefore, the present invention provides more detailed information to users.

Additionally, the present invention also informs the situation of the dish by audio device, which further raises the convenience of the present invention.

Those skilled in the art will readily observe that numerous modifications and alterations of the device and method may be made while retaining the teachings of the invention.

What is claimed is:

1. A display method for a dish of a Digital Video Broadcasting Satellite (DVB-S) comprising:
generating a first period of time of the dish rotation according to an angle the dish is rotating and an angular velocity of the dish; and
outputting the first period of time.

2. The display method of claim 1 wherein outputting the first period of time comprises outputting the first period of time on a display.

3. The display method of claim 1 wherein outputting the first period of time comprises outputting the first period of time on an audio device.

4. The display method of claim 1 further comprising outputting the angle the dish is rotating.

5. The display method of claim 4 wherein outputting the angle the dish is rotating comprises outputting the angle the dish is rotating on a display.

6. The display method of claim 4 wherein outputting the angle the dish is rotating comprises outputting the angle the dish is rotating with an audio device.

7. The display method of claim 1 wherein the angle the dish is rotating is an angle difference between an angle from which the dish starts rotation and an angle at which the dish ends rotation.

8. The display method of claim 7 the angle from which the dish starts rotation is an angle aligned with a first satellite so as to receive signals from the first satellite with the dish and the angle from which the dish ends rotation at is an angle aligned with a second satellite so as to receive signals from the second satellite with the dish.

9. The display method of claim 1 further detecting the angular velocity of the dish.

10. The display method of claim 9 wherein detecting the angular velocity of the dish comprises:
controlling the dish to rotate from a first angle to a second angle;
detecting a second period of time the dish spends rotating from the first angle to the second angle; and
determining the angular velocity of the dish according to an angle difference between the first and the second angles and the second period of time.

11. The display method of claim 10 wherein the first angle aligns with a first satellite so as to receive signals from the first satellite with the dish and the second angle aligns with a second satellite so as to receive signals from the second satellite with the dish.

12. The display method of claim 1 further comprising setting the angular velocity of the dish.
